(19) United States
(12) Patent Application Publication
(10) Pub. No.: US 2007/0094189 A1
(43) Pub. Date: Apr. 26, 2007

(54) Test case extraction apparatus, program and method for software system

(75) Inventors: Hiroshi Yamamoto, Kyoto (JP); Kiyotaka Kasubuchi, Kyoto (JP); Kazuya Hamaguchi, Osaka (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG, CO., LTD.

(21) Appl. No.: 11/541,655

(22) Filed: Oct. 3, 2006

(30) Foreign Application Priority Data
Oct. 4, 2005 (JP) P2005-291366

(51) Int. Cl. G06N 5/00

(52) U.S. Cl. 706/45

(57) ABSTRACT

A test case table stores created test cases and round-by-round test results for each test case. The operator uses a test case extraction dialogue to set test case thinning factors, and also uses a thinning parameter setting dialogue to set a priority order among logics applied for test case extraction. When a test case extraction process is executed, each test case is assigned a priority level for extraction based on the round-by-round test results for each test case in accordance with the set priority order among the logics. High-priority test cases are extracted based on the set thinning factors.

### BACKGROUND OF THE INVENTION

1. Field of the Invention

The present invention relates to techniques for testing a software system, and particularly to a technique for narrowing down test cases when repeatedly executing tests.

2. Description of the Related Art

Conventionally, there have been various known software system development methodologies, including the “waterfall development methodology”, the “prototype development methodology” and the “spiral development methodology”. Software system development phases of these various development methodologies include “requirements definition”, “designing”, “programming”, “testing” and so on. Among these phases, testing of a software system is generally carried out in accordance with a test specification. The test specification describes for each test case a test method, conditions for determining a pass or fail (a success or failure), and so on. Examples of the testing include a “unit test” for performing an operation test mainly on a module-by-module basis, a “join test” for mainly testing consistency between modules, and a “system test” for testing, for example, if there is any operational problem with a whole system.

In software system development, the above-mentioned phases are sometimes repeated. In such a case, testing is repeatedly performed on test cases originally generated for the development or test cases generated when any change has been made in a specification. However, in the software system development, it is sometimes difficult to “test all test cases” for reasons of limitations in a development time, human resources and so on. In such a case, it is necessary to extract test cases that are to be tested in the current phase from all test cases based on previous test results and so on. When the number of test cases is small, test case extraction can be carried out relatively easily even if it is carried out manually. However, as the number of test cases increases, the manual extraction of test cases becomes difficult.

Conventionally, test case extraction in accordance with importance levels of test cases is carried out by computer software processing. For example, the test cases are classified into ranks H, M and L (High, Middle and Low, respectively) in accordance with their importance levels, such that “only rank-H test cases are tested” or “only rank-H and rank-M test cases are tested”. Japanese Laid-Open Patent Publication No. 2003-99283 discloses a test case design support method capable of preferentially and intensively testing important functions in accordance with the situation.

However, according to the above-described related arts, test cases are extracted in accordance with their priority or importance levels, which are established based on characteristics, etc., of a software system, and previous test results are not taken into consideration at the time of extraction. Generally, in software systems, it is relatively unlikely for a function that has never previously malfunctioned to have a new malfunction. As for a function that has frequently malfunctioned, on the other hand, there is a relatively high possibility of malfunctioning again. Accordingly, in the case where test case extraction is carried out without taking previous test results into consideration, it is not ensured that “preferred test cases are extracted”. In addition, the above-described related arts cannot increase/reduce the number of test cases that are to be extracted, in accordance with the length of a development time, for example.

### SUMMARY OF THE INVENTION

Therefore, an object of the present invention is to provide an apparatus capable of efficiently extracting preferred test cases that are to be subjected to the current round of testing from previously generated test cases with consideration of previous test results in software system development.

The present invention has the following features to attain the object mentioned above.

One aspect of the present invention is directed to a test case extraction apparatus for extracting an execution subject test case group from a created test case group, the execution subject test case group consisting of a plurality of test cases that are to be subjected to a current round of testing, the created test case group consisting of a plurality of previously created test cases that are repeatedly tested, the apparatus including: a test case holding section for holding the created test case group; a test result holding section for holding round-by-round test results associated with each test case in the created test case group; a test result reading section for reading the round-by-round test results held in the test result holding section; and a test case extraction section for extracting the execution subject test case group from the created test case group based on the round-by-round test results read by the test result reading section.

According to this configuration, the created test case group consisting of a plurality of previously created test cases are held in the test case holding section, and previous test results for each test case are held in the test result holding section. The test case extraction section extracts test cases that are to be subjected to the current round of testing from the created test case group based on the test results held in the test result holding section. Thus, it is possible to readily extract test cases with consideration of previous test results, thereby efficiently testing a software system.

Preferably, the above apparatus is configured such that the test case extraction section includes a priority order setting section for setting a priority order among the test cases in the created test case group based on the round-by-round test results read by the test result reading section, in order to determine test cases that are to be extracted as the execution subject test case group, and the execution subject test case group is extracted from the created test case group based on the priority order.

According to the above configuration, the priority order setting section assigns each test case a priority level for test case extraction. Test cases that are to be subjected to the current round of testing are extracted from the created test case group based on assigned priority levels. Thus, it is possible to readily extract the test cases.

Preferably, the above apparatus further includes an extraction factor setting section for setting a percentage of test cases that are extracted as the execution subject test case group from the created test case group or a percentage of test cases that are unextracted as the execution subject test case group from the created test case group, and the test case extraction section extracts the execution subject test case group from the created test case group based on the percentage set by the extraction factor setting section.

According to the above configuration, the extraction factor setting section for setting a percentage of test cases that are extracted as current test subjects from the created test case group is provided. Therefore, it is possible to extract test cases that are to be subjected to the current round of testing from all test cases in accordance with the length of a system development time, the number of man-days allowed for testing, etc. This makes it possible to efficiently extract the test cases, and thoroughly examine malfunctions present in the system with a fewer number of test man-days. As a result, it is possible to provide a high quality system with a fewer number of man-days.

Preferably, the above apparatus further includes an extraction logic setting section for setting a priority order among a plurality of logics for extracting the execution subject test case group from the created test case group, and when extracting the execution subject test case group from the created test case group, the test case extraction section applies the plurality of logics in accordance with the priority order set by the extraction logic setting section.

According to the above configuration, it is possible to set a priority order among a plurality of logics for extracting test cases, and the test cases are extracted in accordance with the setting. Thus, it is possible to more flexibly extract test cases depending on system characteristics and so on.

Another aspect of the present invention is directed to a test case extraction program for extracting an execution subject test case group from a created test case group, the execution subject test case group consisting of a plurality of test cases that are to be subjected to a current round of testing, the created test case group consisting of a plurality of previously created test cases that are repeatedly tested, the program causing a computer to execute: a test result reading step for reading round-by-round test results associated with each test case in the created test case group held in a predetermined test case holding section from a predetermined test result holding section holding test results for the plurality of test cases; and a test case extraction step for extracting the execution subject test case group from the created test case group based on the round-by-round test results read by the test result reading step.

Preferably, the above test case extraction program is configured such that the test case extraction step includes a priority order setting step for setting a priority order among the test cases in the created test case group based on the round-by-round test results read by the test result reading step, in order to determine test cases that are to be extracted as the execution subject test case group, and the execution subject test case group is extracted from the created test case group based on the priority order.

Preferably, the above test case extraction program further includes an extraction factor setting step for setting a percentage of test cases that are extracted as the execution subject test case group from the created test case group or a percentage of test cases that are unextracted as the execution subject test case group from the created test case group, and in the test case extraction step the execution subject test case group is extracted from the created test case group based on the percentage set by the extraction factor setting step.

Preferably, the above test case extraction program further includes an extraction logic setting step for setting a priority order among a plurality of logics for extracting the execution subject test case group from the created test case group, and in the test case extraction step, when extracting the execution subject test case group from the created test case group, the plurality of logics are applied in accordance with the priority order set by the extraction logic setting step.

Still another aspect of the present invention is directed to a test case extraction method for extracting an execution subject test case group from a created test case group, the execution subject test case group consisting of a plurality of test cases that are to be subjected to a current round of testing, the created test case group consisting of a plurality of previously created test cases that are repeatedly tested, the method including: a test result reading step for reading round-by-round test results associated with each test case in the created test case group held in a predetermined test case holding section from a predetermined test result holding section holding test results for the plurality of test cases; and a test case extraction step for extracting the execution subject test case group from the created test case group based on the round-by-round test results read by the test result reading step.

Preferably, the above test case extraction method is configured such that the test case extraction step includes a priority order setting step for setting a priority order among the test cases in the created test case group based on the round-by-round test results read by the test result reading step, in order to determine test cases that are to be extracted as the execution subject test case group, and the execution subject test case group is extracted from the created test case group based on the priority order.

Preferably, the above test case extraction method further includes an extraction factor setting step for setting a percentage of test cases that are extracted as the execution subject test case group from the created test case group or a percentage of test cases that are unextracted as the execution subject test case group from the created test case group, and in the test case extraction step the execution subject test case group is extracted from the created test case group based on the percentage set by the extraction factor setting step.

Preferably, the above test case extraction method further includes an extraction logic setting step for setting a priority order among a plurality of logics for extracting the execution subject test case group from the created test case group, and in the test case extraction step, when extracting the execution subject test case group from the created test case group, the plurality of logics are applied in accordance with the priority order set by the extraction logic setting step.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a test case extraction apparatus according to an embodiment of the present invention.

FIG. 2 is a hardware configuration diagram of an overall software system development environment according to the embodiment.

FIG. 3 is a conceptual diagram for explaining a test project in the embodiment.

FIG. 4 is a diagram illustrating a record format of a test specification table in the embodiment.

FIG. 5 is a diagram illustrating a record format of a test case table in the embodiment.

FIG. 6 is a flow chart illustrating an exemplary processing procedure for a test case extraction process in the embodiment.

FIG. 7 is a diagram illustrating a test case extraction dialogue in the embodiment.

FIG. 8 is a diagram illustrating a thinning parameter setting dialogue in the embodiment.

FIG. 9 is a flow chart illustrating a detailed processing procedure for an extraction process in the embodiment.

FIG. 10 is a flow chart illustrating a detailed processing procedure for a table creation process in the embodiment.

FIG. 11 is a diagram illustrating a table layout of a priority order setting table in the embodiment.

FIG. 12 is a table for explaining a test result prioritizing logic process in the embodiment.

FIG. 13 is a table for explaining the test result prioritizing logic process in the embodiment.

FIGS. 14A and 14B are tables for explaining the test result prioritizing logic process in the embodiment.

FIGS. 15A and 15B are tables for explaining the test result prioritizing logic process in the embodiment.

FIG. 16 is a flow chart illustrating a detailed processing procedure for the test result prioritizing logic process in the embodiment.

FIG. 17 is a table for explaining a test execution prioritizing logic process in the embodiment.

FIG. 18 is a table for explaining the test execution prioritizing logic process in the embodiment.

FIGS. 19A and 19B are tables for explaining the test execution prioritizing logic process in the embodiment.

FIGS. 20A and 20B are tables for explaining the test execution prioritizing logic process in the embodiment.

FIG. 21 is a flow chart illustrating a detailed processing procedure for the test execution prioritizing logic process in the embodiment.

FIG. 22 is a flow chart illustrating a detailed processing procedure for a test result final order setting process in the embodiment.

FIG. 23 is a table for explaining the test result final order setting process in the embodiment.

FIGS. 24A and 24B are diagrams each illustrating a record format after normalization of a test specification table in a first variant of the embodiment.

FIGS. 25A and 25B are diagrams each illustrating a record format after normalization of the test specification table in the first variant of the embodiment.

FIG. 26 is a table for explaining a test execution prioritizing logic process in a second variant of the embodiment.

FIG. 27 is a table for explaining the test execution prioritizing logic process in the second variant of the embodiment.

FIGS. 28A through 28C are charts illustrating changes in proportion of each type of test result among all test results in the course of testing in a third variant of the embodiment.

FIG. 29 is a flow chart for explaining a processing flow during a test phase in the third variant of the embodiment.

### DESCRIPTION OF THE PREFERRED EMBODIMENTS

Hereinafter, an embodiment of the present invention will be described with reference to the accompanying drawings.

<1. Overall Configuration>

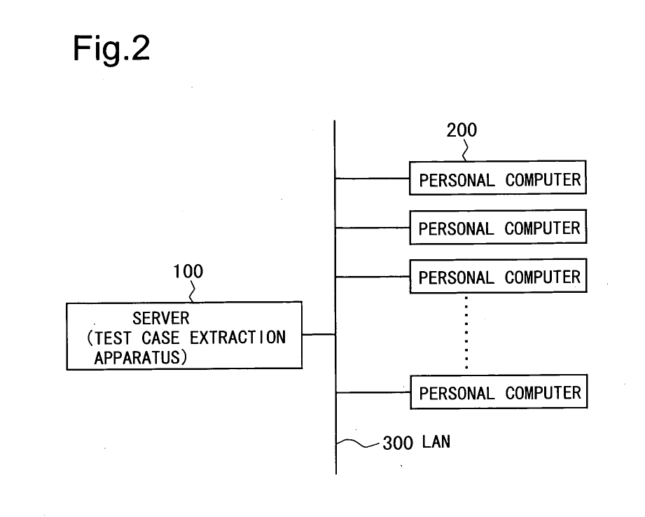

FIG. 2 is a hardware configuration diagram of an overall software system development environment including a test case extraction apparatus according to an embodiment of the present invention. This system is composed of a server 100 and a plurality of personal computers 200. The server 100 and each personal computer 200 are connected to each other via a LAN 300. The server 100 executes processing in accordance with a request from each personal computer 200, and stores files, databases, etc., that can be commonly referenced from each personal computer 200. In addition, the server 100 also serves as an apparatus for extracting test cases that are to be subjected to the current round of testing in accordance with the length of a development time and so on in software system development. Therefore, the server 100 is referred to below as the “test case extraction apparatus”. The personal computers 200 perform tasks such as programming for developing a software system, execution of tests, entry of test results and so on.

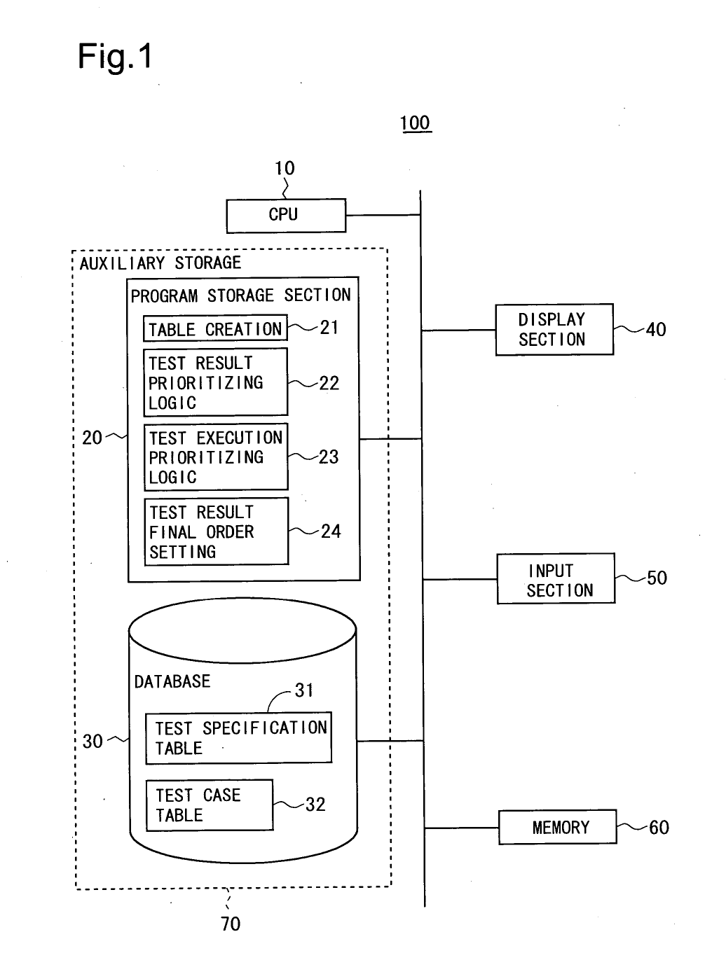

FIG. 1 is a block diagram illustrating the configuration of the test case extraction apparatus 100. The test case extraction apparatus 100 includes a CPU 10, a display section 40, an input section 50, a memory 60 and an auxiliary storage 70. The auxiliary storage 70 includes a program storage section 20 and a database 30. The CPU 10 performs arithmetic processing in accordance with a given instruction. The program storage section 20 has stored therein four programs (execution modules) 21 to 24, which are labeled “TABLE CREATION”, “TEST RESULT PRIORITIZING LOGIC”, “TEST EXECUTION PRIORITIZING LOGIC” and “TEST RESULT FINAL ORDER SETTING”, respectively. The database 30 has stored therein two tables 31 and 32, which are labeled “TEST SPECIFICATION” and “TEST CASE”, respectively. The display section 40 displays an operation screen, which is used by an operator for performing test case extraction, for example. The input section 50 receives an input from the operator via a mouse or a keyboard. The memory 60 temporarily stores data required for arithmetic processing by the CPU 10.

<2. Test Specification>

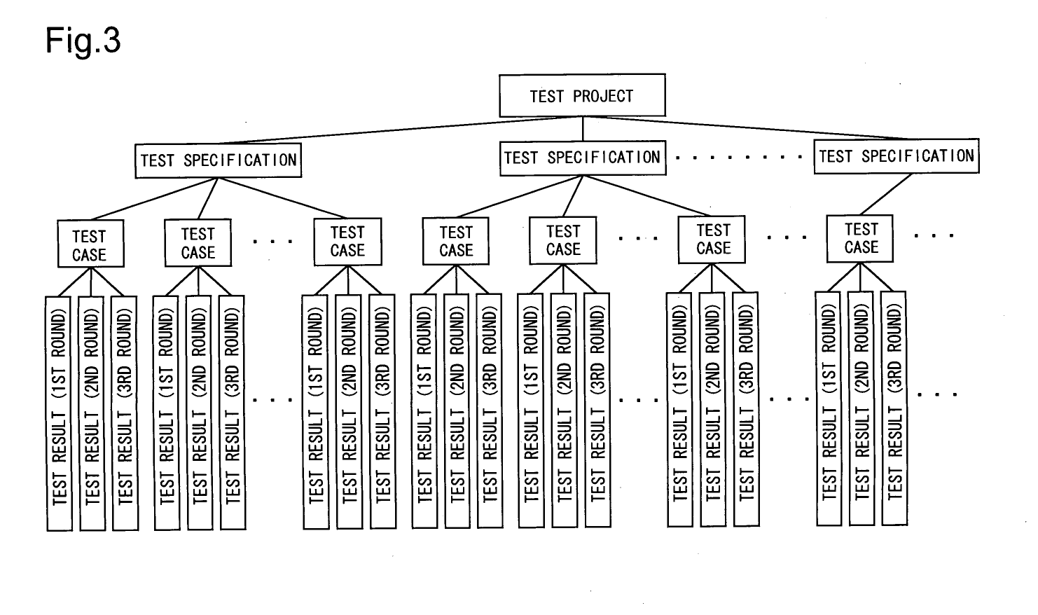

In software system development, generally, a test project is devised for planning a system test. In the present embodiment, a single test project is devised for developing a single software system. FIG. 3 is a conceptual diagram for explaining a test project in the present embodiment. As shown in FIG. 3, a plurality of test specifications are generated for a single test project. Each test specification includes a plurality of test cases, and a test result is added as a test case attribute upon each execution of a test.

Each test specification is implemented as a record of the test specification table 31 in the database 30. Each test case is implemented as a record of the test case table 32 in the database 30. In addition, each test result is an item contained in the test case table 32.

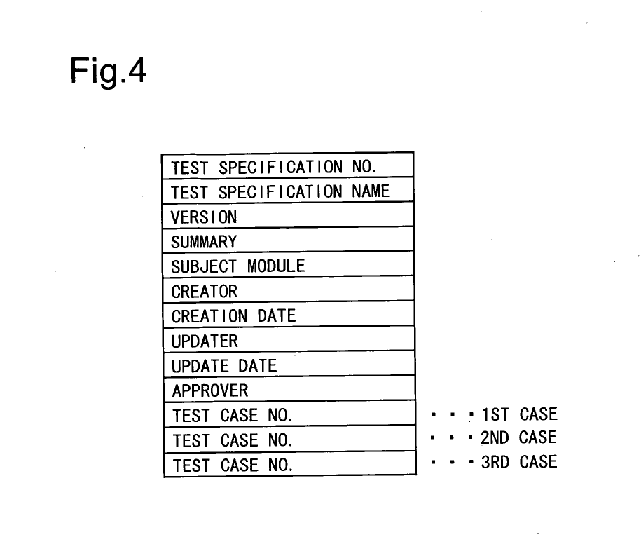

FIG. 4 is a diagram illustrating a record format of the test specification table 31. The test specification table 31 contains a plurality of items, which are labeled “TEST SPECIFICATION NO.”, “TEST SPECIFICATION NAME”, “VERSION”, “SUMMARY”, “SUBJECT MODULE”, “CREATOR”, “CREATION DATE”, “UPDATER”, “UPDATE DATE”, “APPROVER” and “TEST CASE NO.”, respectively. Note that “TEST CASE NO.” is repeated by the number of test cases included in the test specification.

In item fields of the test specification table 31 (regions where data items are stored), data items as described below are stored. Stored in the “TEST SPECIFICATION NO.” field is a number for identifying a test specification, which is uniquely assigned for each test project. Stored in the “TEST SPECIFICATION NAME” field is a name by which a developer, a tester, etc., can identify the test specification. Stored in the “VERSION” field is a version of the test specification. Stored in the “SUMMARY” field is a description summarizing the test specification. Stored in the “CREATOR” field is a name of a test specification creator. Stored in the “CREATION DATE” field is a creation date of the test specification. Stored in the “UPDATER” field is a name of a person who last updated the test specification. Stored in the “UPDATE DATE” field is an update date of the test specification. Stored in the “APPROVER” field is a name of a person who approved the details of the test specification. Stored in the “TEST CASE NO.” field is a number for identifying a test case, which is uniquely assigned within a test project.

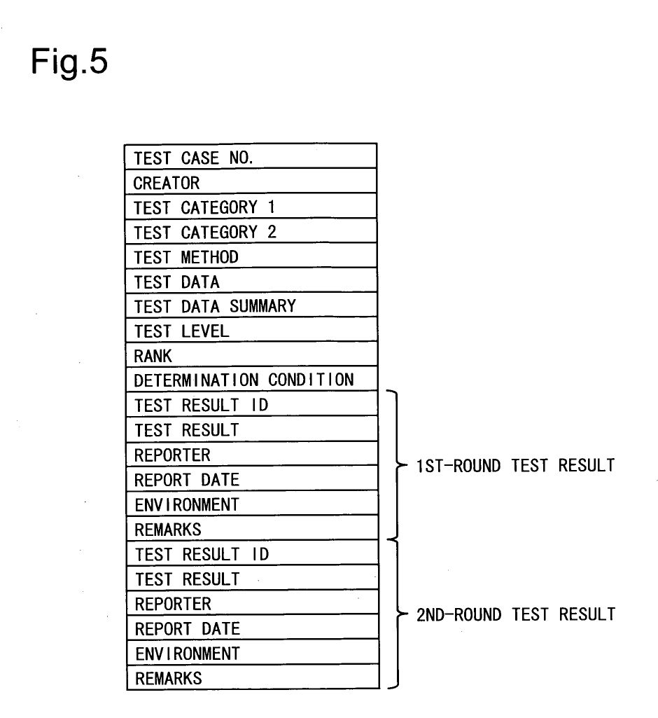

FIG. 5 is a diagram illustrating a record format of the test case table 32. The test case table 32 contains a plurality of items, which are labeled “TEST CASE NO.”, “CREATOR”, “TEST CATEGORY 1”, “TEST CATEGORY 2.”, “TEST METHOD”, “TEST DATA”, “TEST DATA SUMMARY”, “TEST LEVEL”, “RANK”, “DETERMINATION CONDITION”, “TEST RESULT ID”, “TEST RESULT”, “REPORTER”, “REPORT DATE”, “ENVIRONMENT” and “REMARKS”, respectively. Note that “TEST RESULT ID”, “TEST RESULT”, “REPORTER”, “REPORT DATE”, “ENVIRONMENT” and “REMARKS” are repeated by the number of tests performed on an associated test case. It should be also noted that in the present embodiment, a test case holding section is realized by the test case table 32. Further, a test result holding section is realized by the above-mentioned “TEST RESULT” field in the test case table 32. Furthermore, a created test case group is realized by all records stored in the test case table 32.

In item fields of the test case table 32, data items as described below are stored. Stored in the “TEST CASE NO.” field is a number for identifying a test case, which is uniquely assigned within a test project. Note that the “TEST CASE NO.” field in the test specification table 31 and the “TEST CASE NO.” field in the test case table 32 are linked with each other. Stored in the “CREATOR” field is a name of a test case creator. Stored in the “TEST CATEGORY 1” field is a name of a category into which the test case is categorized in accordance with a predetermined rule. The category name may be “normal system”, “abnormal system” or “load”, for example. Stored in the “TEST CATEGORY 2” field is a name of a category into which the test case is categorized in accordance with a rule different from that for the “TEST CATEGORY 1” field. The category name may be “function” or “boundary value”, for example. Stored in the “TEST METHOD” field is a description explaining a method for executing a test. Stored in the “TEST DATA” field is a description for specifying data for executing the test (e.g., a full pathname). Stored in the “TEST DATA SUMMARY” field is a description summarizing the test data. Stored in the “TEST LEVEL” field is a level of the test case. The level may be “unit test”, “join test” or “system test”, for example. Stored in the “RANK” field is an importance level of the test case. The importance level may be “H”, “M” or “L”, for example. Stored in the “DETERMINATION CONDITION” field is a description explaining the criterion for determining a pass or fail in the test. Stored in the “TEST RESULT ID” field is a number for identifying a test result among test cases. Stored in the “TEST RESULT” field is a result for execution of the test. In the present embodiment, the test result may be “success”, “failure”, “untested” or “unexecuted”. Stored in the “REPORTER” field is a name of a person who reported the test result. Stored in the “REPORT DATE” field is a report date of the test result. Stored in the “ENVIRONMENT” field is a description explaining a system environment or the like at the time of test execution. Stored in the “REMARKS” field is a description such as a comment on execution of the test.

As for the test result, “success” is meant to indicate that the test result is successful (pass), “failure” is meant to indicate that the test result is unsuccessful (fail), “untested” is meant to indicate that no test is performed on an associated test case, and “unexecuted” is meant to indicate that the test case has not yet been tested in the current test phase. Note that pass/fail distinction information is realized by a test result indicating “success” and a test result indicating “failure”. Also, no-execution information is realized by a test result indicating “untested” and a test result indicating “unexecuted”.

In the present embodiment, a process for extracting test cases (a test case extraction process) is performed based on data (records) stored in the test specification table 31 and the test case table 32. Accordingly, it is prerequisite that data is previously stored in the test specification table 31 and the test case table 32 before the test case extraction process is performed.

<3. Test Case Extraction Process>

<3.1 Overall Process>

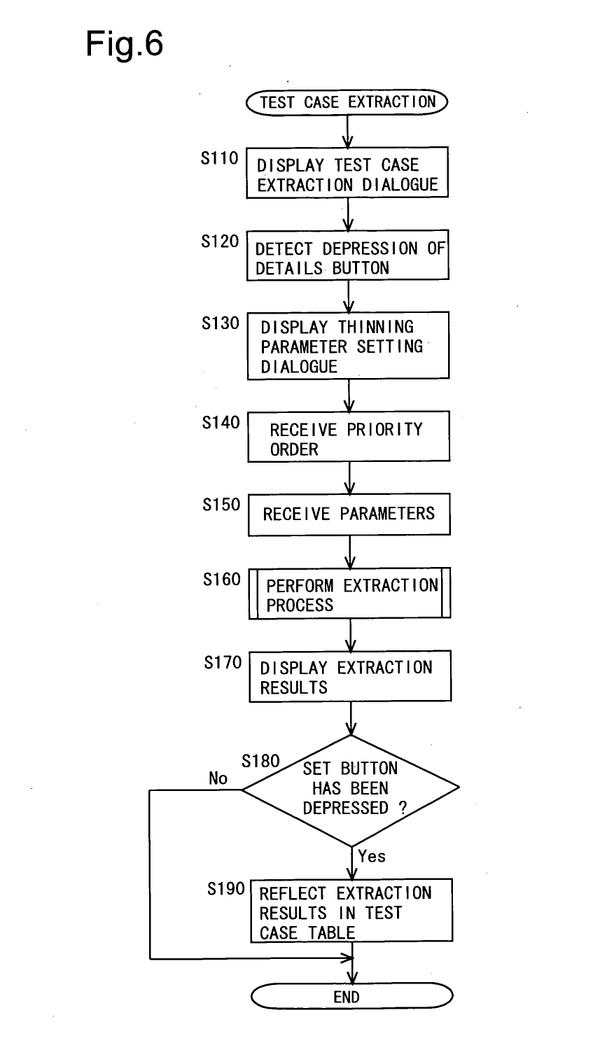

Next, the test case extraction process is described. FIG. 6 is a flow chart illustrating an exemplary processing procedure for the test case extraction process in the present embodiment. The test case extraction apparatus 100 displays a test case extraction dialogue on the display section 40 in accordance with the operator's instruction to execute a test case extraction process (step S110).

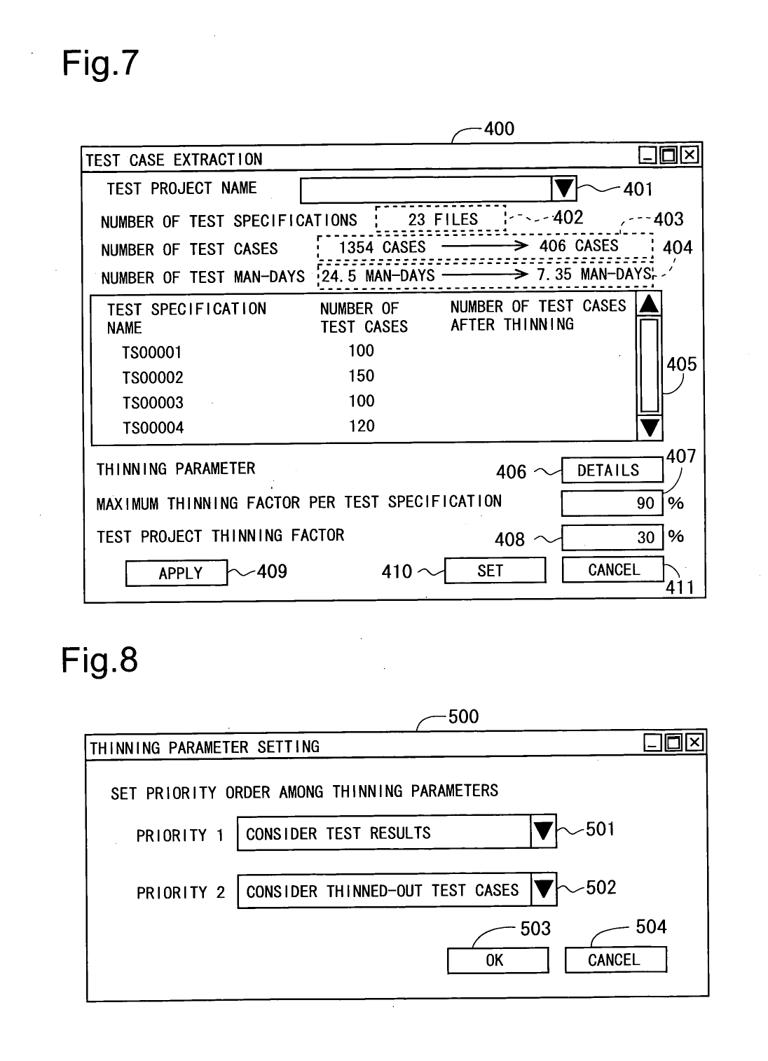

FIG. 7 is a diagram illustrating a test case extraction dialogue 400. The test case extraction dialogue 400 includes a list box 401 for selecting a test project name, a display region 402 for displaying the number of test specifications included in a test project selected in the list box 401 (hereinafter, referred to as the “test specification number display region 402”), a display region 403 for displaying the numbers of test cases before and after executing the test case extraction process (hereinafter, referred to as the “test case number display region 403”), a display region 404 for displaying the numbers of man-days for a test before and after executing the test case extraction process (hereinafter, referred to as the “test man-day number display region 404”), a display region 405 for displaying the numbers of test cases for each test specification before and after executing the test case extraction process (hereinafter, referred to as the “extraction result display region 405”), a details button 406 for displaying a thinning parameter setting dialogue 500, which will be described later, a text box 407 for setting a maximum test case thinning factor for each test specification (hereinafter, referred to as the “test specification thinning factor setting text box 407”), a text box 408 for setting a test case thinning factor for the entire test project (hereinafter, referred to as the “test project thinning factor setting text box 408”), an apply button 409 for executing an extraction process based on, for example, a parameter set by the operator, a set button 410 for reflecting extraction results, which are displayed in the extraction result display region 405, in the test case table 32, and a cancel button 411 for canceling the test case extraction process. Note that an extraction factor setting section is realized by the test specification thinning factor setting text box 407 and the test project thinning factor setting text box 408.

Upon completion of step S110, the procedure proceeds to step S120, where the test case extraction apparatus 100 detects depression of the details button 406 by the operator. As a result, the test case extraction apparatus 100 displays the thinning parameter setting dialogue 500 on the display section 40 (step S130).

FIG. 8 is a diagram illustrating the thinning parameter setting dialogue 500. The thinning parameter setting dialogue 500 includes list boxes 501 and 502 for setting a priority order among logics applied at the time of test case extraction, an OK button 503 for determining settings, and a cancel button 504 for canceling settings. Note that an extraction logic setting section is realized by the thinning parameter setting dialogue 500.

Upon completion of step S130, the operator uses the list boxes 501 and 502 in the thinning parameter setting dialogue 500 to set a priority order among logics applied at the time of test case extraction. After the setting, when the operator depresses the OK button 503, the test case extraction apparatus 100 receives the priority order among the logics applied at the time of test case extraction (step S140). Note that when the OK button 503 or the cancel button 504 in the thinning parameter setting dialogue 500 is depressed, the thinning parameter setting dialogue 500 disappears, so that the test case extraction dialogue 400 is displayed again.

After the test case extraction dialogue 400 is displayed again, the test case extraction apparatus 100 receives the operator's entry of thinning factors in the test specification thinning factor setting text box 407 and the test project thinning factor setting text box 408 (step S150). The “thinning factor” refers to a percentage of test cases that are excluded from current test subjects among all test cases stored in the test case table 32. For example, in the case where there are ten test cases in total, if the thinning factor is set to 90%, only one test case is subjected to the current round of testing.

After completion of step S150, when the operator depresses the apply button 409, the test case extraction apparatus 100 executes an extraction process (step S160). The details of the extraction process will be described later. Note that a test case extraction section is realized by step S160.

Upon completion of step S160, the procedure proceeds to step S170, where the test case extraction apparatus 100 displays extraction results in the test case number display region 403, the test man-day number display region 404 and the extraction result display region 405. Thereafter, the test case extraction apparatus 100 determines which one of the set button 410 and the cancel button 411 has been depressed by the operator (step S180). When it is determined that the set button 410 has been depressed, the procedure proceeds to step S190. On the other hand, when it is determined that the cancel button 411 has been depressed, the test case extraction process is completed. Note that it may be so configured that, when the cancel button 411 has been depressed, the test case extraction dialogue 400 is temporarily cleared and the procedure returns to step S110.

In step S190, the test case extraction apparatus 100 reflects the extraction results in the test case table 32. Specifically, the current results for the test cases that have been excluded from the current test subjects by the extraction process are presented as “untested” in the test case table 32. Upon completion of step S190, the test case extraction process is completed.

<3.2 Extraction Process>

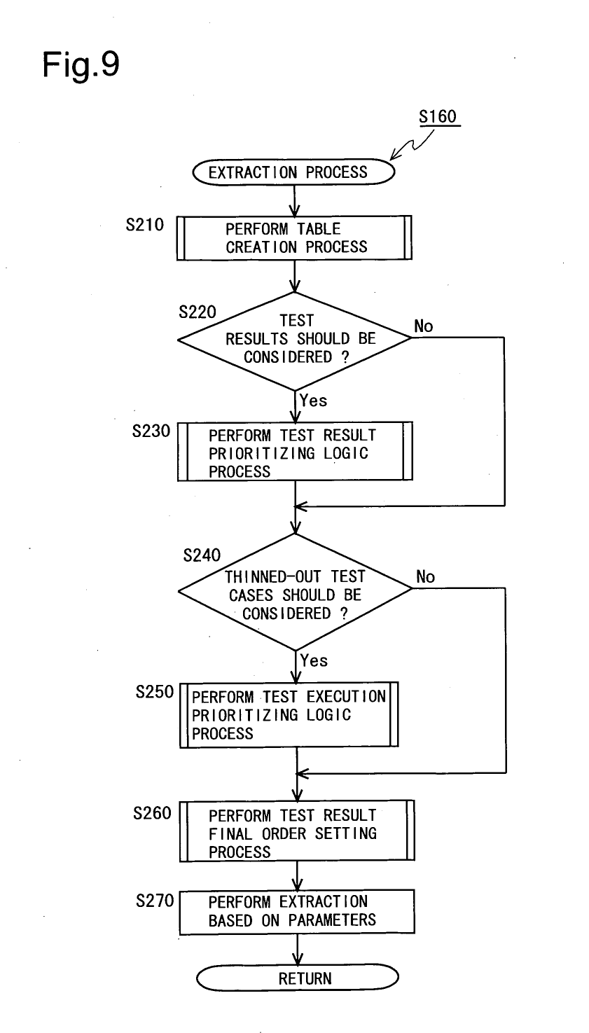

Next, the above-described extraction process in step S160 is further described in detail. FIG. 9 is a flow chart illustrating a detailed processing procedure for the extraction process in the present embodiment. After the extraction process is started, the test case extraction apparatus 100 creates a table for setting a priority order among test cases (hereinafter, referred to as the “priority order setting table”) (step S210). Upon completion of step S210, the procedure proceeds to step S220, where it is determined whether or not to consider previous test results at the time of test case extraction. Note that whether or not to consider the test results is determined based on the operator's settings in the thinning parameter setting dialogue 500. When it is determined that the test results are taken into consideration, the procedure proceeds to step S230. On the other hand, when it is determined that the test results are not taken into consideration, the procedure proceeds to step S240. In step S230, a test result prioritizing logic process is carried out. The details of the test result prioritizing logic process will be described later. Upon completion of the test result prioritizing logic process, the procedure proceeds to step S240.

In step S240, it is determined whether or not to consider test cases that have been thinned out at the time of test case extraction. “Considering thinned-out test cases” is meant to indicate that test cases having a test result of “untested”, rather than test cases having a test result of “success”, are preferentially extracted as current test subjects. Note that whether or not to consider the thinned-out test cases is determined based on the operator's settings in the thinning parameter setting dialogue 500. When it is determined that the thinned-out test cases are taken into consideration, the procedure proceeds to step S250. On the other hand, when it is determined that the thinned-out test cases are not taken into consideration, the procedure proceeds to step S260. In step S250, a test execution prioritizing logic process is carried out. The details of the test execution prioritizing logic process will be described later. Upon completion of the test execution prioritizing logic process, the procedure proceeds to step S260.

In step S260, a test result final order setting process is carried out. The details of the test result final order setting process will be described later. Upon completion of the test result final order setting process, the procedure proceeds to step S270. In step S270, based on previously set parameters, high-priority test cases (an execution subject test case group) are extracted. The term “high-priority” is meant to indicate that a value (a numeral value) indicating a priority level is small. Upon completion of step S270, the extraction process is completed.

Note that in the present embodiment, a priority order setting section is realized by steps S220 through S260.

<3.3 Table Creation>

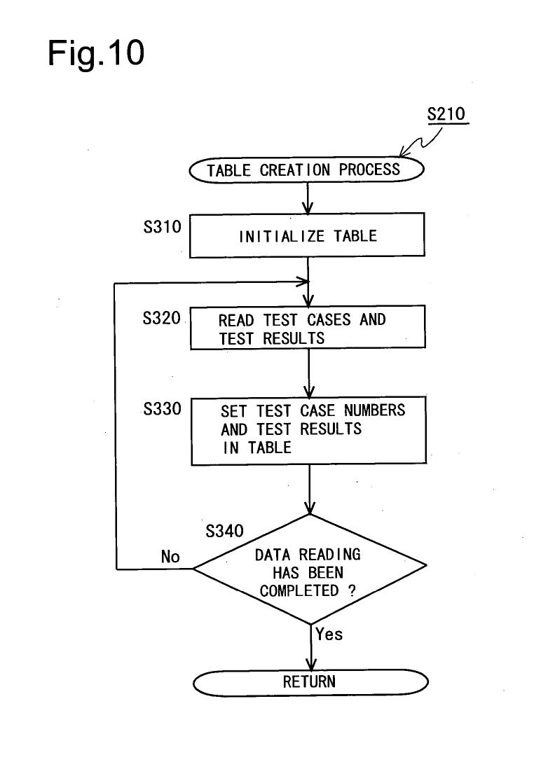

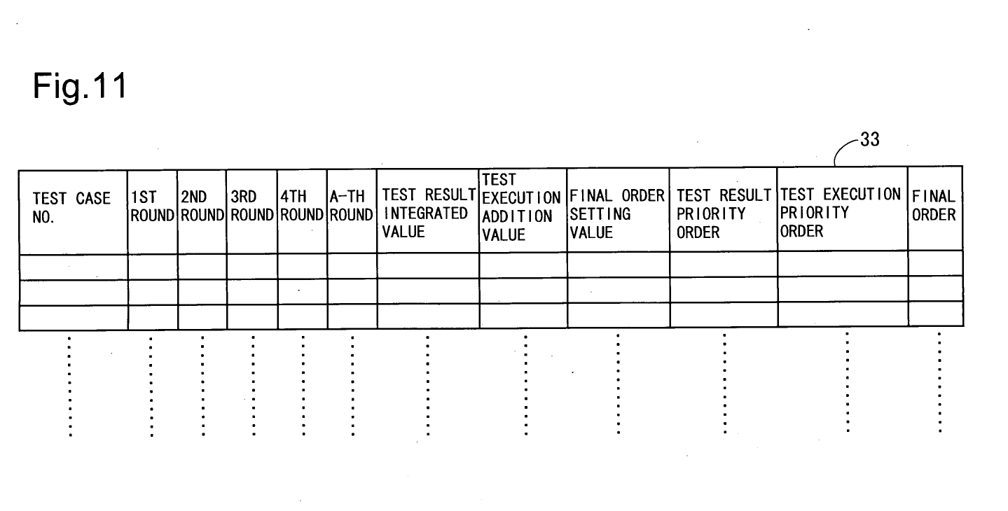

FIG. 10 is a flow chart illustrating a detailed processing procedure for the table creation process in step S210 of FIG. 9. After the table creation process is started, the test case extraction apparatus 100 initializes the priority order setting table 33 (step S310). FIG. 11 is a diagram illustrating a table layout of the priority order setting table 33. The priority order setting table 33 contains a plurality of items, which are labeled “TEST CASE NO.”, “1ST ROUND”, “2ND ROUND”, . . . , “A-TH ROUND” (where A is the number of previously executed tests), “TEST RESULT INTEGRATED VALUE”, “TEST EXECUTION ADDITION VALUE”, “FINAL ORDER SETTING VALUE”, “TEST RESULT PRIORITY ORDER”, “TEST EXECUTION PRIORITY ORDER” and “FINAL PRIORITY ORDER”. Note that a record stored in the priority order setting table 33 is referred to below as the “test case result record”. Upon completion of step S310, the procedure proceeds to step S320, where test case records for test specifications included in the test project are read. Specifically, based on the test specification table 31 and the test case table 32, a test case number and round-by-round test results are read for each test case included in the test project. Thereafter, the procedure proceeds to step S330, where the test case numbers and the test results (1st through A-th rounds) for the test case records read in step S320 are written to the priority order setting table 33. Upon completion of step S330, the procedure proceeds to step S340, where it is determined whether or not all test case records for all test specifications included in the test project have been completely read. When it is determined that the reading has not been completed, the procedure returns to step S320. On the other hand, when it is determined that the reading has been completed, the table creation process is completed. Note that a test result reading section is realized by step S320. In addition, as shown in FIG. 1, a program for realizing the table creation process is stored in the program storage section 20 under the label “TABLE CREATION”.

<3.4 Test Result Prioritizing Logic Process>

<3.4.1 Notion of the Test Result Prioritizing Logic>

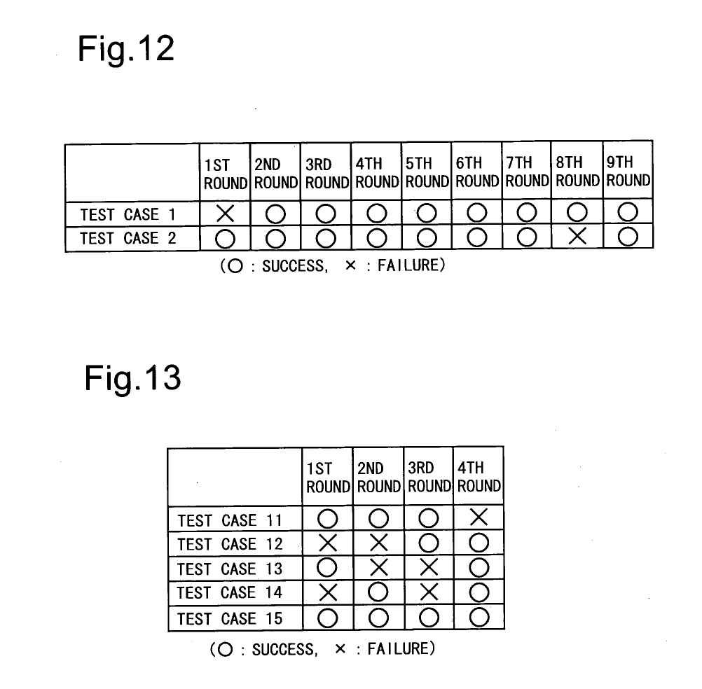

Next, the test result prioritizing logic process is described. First, consider which one of two test cases should be assigned a higher priority level when nine rounds of tests have been previously executed with respect to the two test cases as shown in FIG. 12. As for test case 1, the first round test result is a failure, but a program was modified, so that all test results for the second and subsequent rounds are successes. As for test case 2, on the other hand, the first through seventh round test results are successes, but a program was modified after executing the seventh round test, so that the eighth round test result is a failure. Thereafter, the program was modified, so that the ninth round test result is a success. In this case, it is conceivable that when the next test is executed, the test case 2 having failed more recently is more likely to fail than the test case 1. The reason for this is that the program associated with the test case 2 has been modified more recently and cannot be considered as operating more stably so that its reliability based on the test results is low. Therefore, in the case where the test results as shown in FIG. 12 are obtained, the test case 2 is assigned a higher priority level over the test case 1 according to the test result prioritizing logic.

While a simple example has been given above, a more complicated example will be given next. Consider a case of extracting three test cases from five test cases when four rounds of tests have been previously executed with respect to the five test cases as shown in FIG. 13. In this case, it is conceivable that the test cases are extracted, for example, in accordance with the following conditions. A first condition is that “a test case having failed in the last test is prioritized”. A second condition is that “a test case having the largest number of previous failures is prioritized”. In this case, test case 11 is first extracted in accordance with the first condition. Three test cases 12, 13 and 14 are then selected in accordance with the second condition. However, only two out of the three should be extracted, and therefore it is necessary to set another condition or the like.

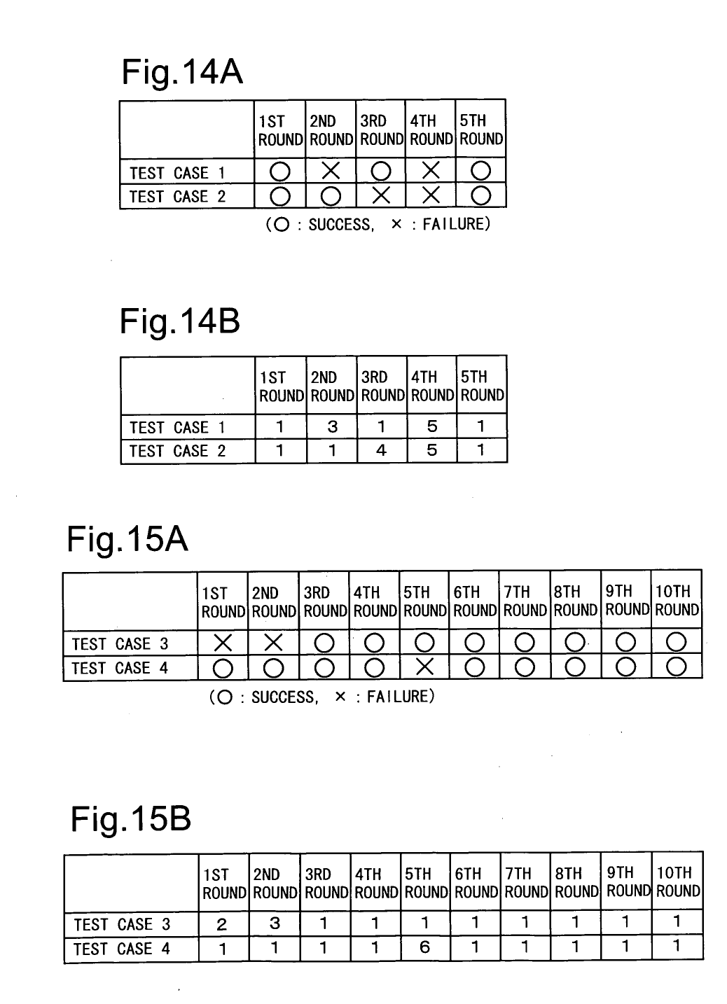

Accordingly, in the present embodiment, previous test results are digitized, such that a test case having failed more recently is assigned a higher priority level, in order to determine a priority order of test case extraction based on the digitized values. FIGS. 14A and 14B are tables for explaining an example of digitizing test results. As shown in FIG. 14A, five rounds of tests have been previously executed with respect to two test cases. Test case 1 has failed in the second and fourth rounds, and test case 2 has failed in the third and fourth rounds. In the present embodiment, a successful test result is digitized into “1”. On the other hand, an unsuccessful test result is digitized into, for example, “m+1”, if it is the m-th round test result (where m is an integer). For example, in the case where the second round test result is a failure, the second round test result is digitized into “3”. As a result, the test results shown in FIG. 14A are digitized as shown in FIG. 14B.

After each test result is digitized, the product of values obtained by digitizing round-by-round test results is calculated for each test case. The product value is referred to below as the “test result integrated value”. In the present embodiment a test case having a larger test result integrated value is assigned a higher priority level in accordance with the test result prioritizing logic.

In the example shown in FIG. 14B, a test result integrated value J1 of the test case 1 is calculated by the following equation (1).
J1=1×3×1×5×1=15 (1)

A test result integrated value J2 of the test case 2 is calculated by the following equation (2).
J2=1×1×4×5×1=20 (2)

Thus, the test case 2 is assigned a higher priority level over the test case 1 in accordance with the test result prioritizing logic.

Next, another example is described. In the case where test results as shown in FIG. 15A are obtained for two test cases, the test results are digitized as shown in FIG. 15B. In this case, a test result integrated value of test case 3 is “6”. A test result integrated value of test case 4 is also “6”. Here, if the priority order is determined based only on the test result integrated values, the test cases 3 and 4 are assigned the same priority level. If such is the case, in the present embodiment, the test case 4 having failed more recently is assigned a high priority level over the test case 3.

<3.4.2 Processing Procedure for the Test Result Prioritizing Logic Process>

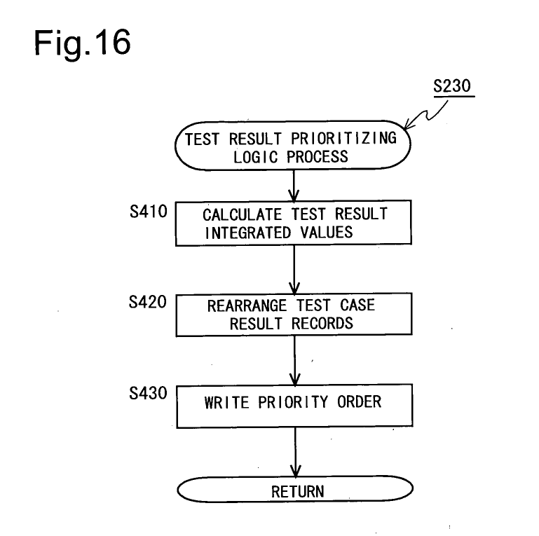

FIG. 16 is a flow chart illustrating a detailed processing procedure for the test result prioritizing logic process in step S230 of FIG. 9. After the test result prioritizing logic process is started, the test case extraction apparatus 100 calculates test result integrated values for all test cases of all test specifications included in the test project (step S410). The calculated test result integrated values are written for each test case to the field labeled “TEST RESULT INTEGRATED VALUE” in the priority order setting table 33. Upon completion of step S410, the procedure proceeds to step S420, where test case result records stored in the priority order setting table 33 are rearranged in decreasing order of the test result integrated values. Thereafter, the procedure proceeds to step S430, where a priority level is written for each test case to the field labeled “TEST RESULT PRIORITY ORDER” in the priority order setting table 33. Upon completion of step S430, the test result prioritizing logic process is completed. Note that a program for realizing the test result prioritizing logic process is stored in the program storage section 20 under the label “TEST RESULT PRIORITIZING LOGIC” as shown in FIG. 1.

<3.5 Test Execution Prioritizing Logic Process>

<3.5.1 Notion of the Test Execution Prioritizing Logic>

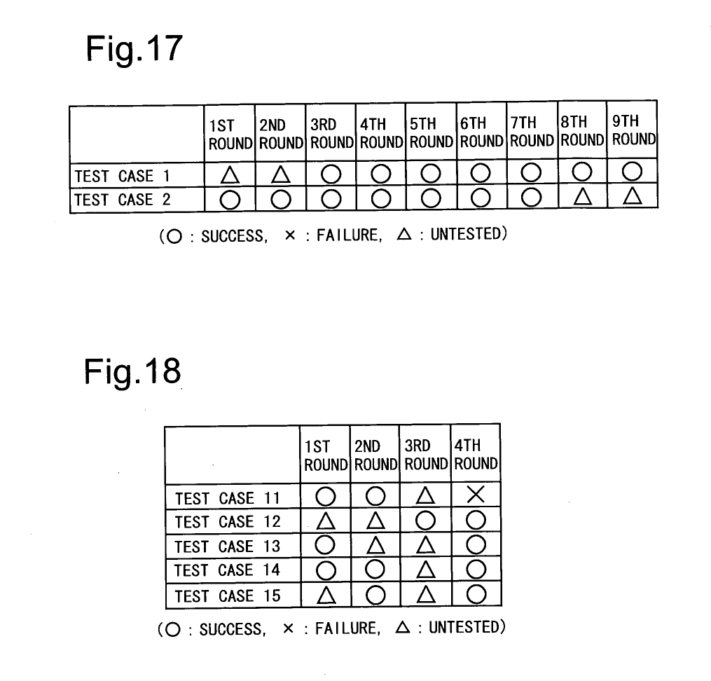

Next, the test execution prioritizing logic process is described. First, consider which one of two test cases should be assigned a higher priority level when nine rounds of tests have been previously executed with respect to the two test cases as shown in FIG. 17. Note that the test result “untested” is meant to indicate that no test has been executed. As for test case 1, the first and second test results are “untested”, but the third and subsequent test results are all successes. As for test case 2, on the other hand, the first through seventh round test results are successes, but the eighth and ninth round test results are “untested”. In this case, it is conceivable that when the next test is executed, the test case 2 having had a test result of “untested” more recently is more likely to fail than the test case 1. The reason for this is that after recent program modification, tests have been executed for the test case 1, whereas no test has been executed for the test case 2 so that there is a possibility where the program modification might affect a test result for the test case 2. Accordingly, in the case where the test results as shown in FIG. 17 are obtained, the test case 2 is assigned a higher priority level over the test case 1 according to the test execution prioritizing logic.

While a simple example has been given above, amore complicated example will be given next. Consider a case of extracting three test cases from five test cases when four rounds of tests have been previously executed with respect to the five test cases as shown in FIG. 18. In this case, it is conceivable that the test cases are extracted, for example, in accordance with the following conditions. A first condition is that “a test case having failed in the last test is prioritized”. A second condition is that “a test case having had a test result of “untested” more recently is prioritized”. In this case, test case 11 is first extracted in accordance with the first condition. Three test cases 13, 14 and 15 are then selected in accordance with the second condition. However, only two out of the three should be extracted, and therefore it is necessary to set another condition or the like.

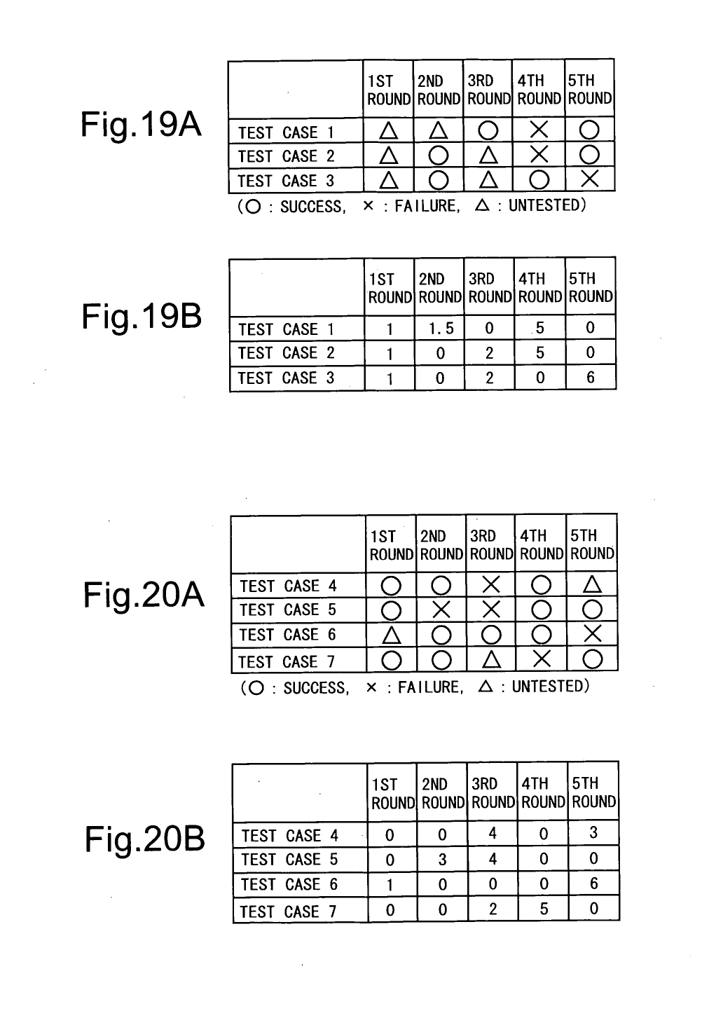

Accordingly, test results are digitized as in the above-described test result prioritizing logic process. In the present embodiment, previous test results are digitized, such that a test case having had a test result of “untested” more recently is assigned a higher priority level, in order to determine a priority order of test case extraction based on the digitized values. FIGS. 19A and 19B are tables for explaining an example of digitizing test results. As shown in FIG. 19A, five rounds of tests have been previously executed with respect to three test cases. In the present embodiment, a successful test result is digitized into “0”. An unsuccessful test result is digitized into, for example, “m+1”, if it is the m-th round test result (where m is an integer). For example, in the case where the second round test result is a failure, the second round test result is digitized into “3”. In addition, a test result of “untested” is digitized into “(n+1)×0.5”, if it is the n-th round test result (where n is an integer). For example, in the case where the second round test result is “untested”, the second round test result is digitized into “1.5”. As a result, the test results shown in FIG. 19A are digitized as shown in FIG. 19B.

After each test result is digitized, the sum of values obtained by digitizing round-by-round test results is calculated for each test case. The sum value is referred to below as the “test execution addition value”. In the present embodiment, a test case having a larger test execution addition value is assigned a higher priority level in accordance with the test execution prioritizing logic.

In the example shown in FIG. 19B, a test execution addition value K1 of test case 1 is calculated by the following equation (3).
K1=1+1.5+0+5+0=7.5 (3)

A test execution addition value K2 of test case 2 is calculated by the following equation (4).
K2=1+0+2+5+0=8 (4)

A test execution addition value K3 of test case 3 is calculated by the following equation (5).
K3=1+0+2+0+6=9 (5)

Thus, according to the test execution prioritizing logic, a priority order among the above three test cases is set such that the test case 3 is assigned the highest priority level, and the test case 1 is assigned the lowest priority level.

Next, another example is described. In the case where test results as shown in FIG. 20A are obtained for four test cases, the test results are digitized as shown in FIG. 20B. In this case, the test execution addition value is “7” for all test cases 4 through 7. Here, when the priority order is determined based only on the test execution addition values, the test cases 4 through 7 are all assigned the same priority level. If such is the case, in the present embodiment, the priority order is determined in accordance with the following three conditions. A first condition is that “a test case having failed more recently is assigned a higher priority level”. A second condition is that “a test case having the largest number of previous failures is assigned a higher priority level”. A third condition is that “a test case having had a test result of “untested” more recently is assigned a higher priority level. In this case, test case 6 is first extracted in accordance with the first condition. Test case 5 is then extracted in accordance with the second condition. Further, test case 4 is extracted in accordance with the third condition. The resulting priority order among the above four test cases is “test case 6, test case 5, test case 4, test case 7”.

<3.5.2 Processing Procedure for the Test Execution Prioritizing Logic Process>

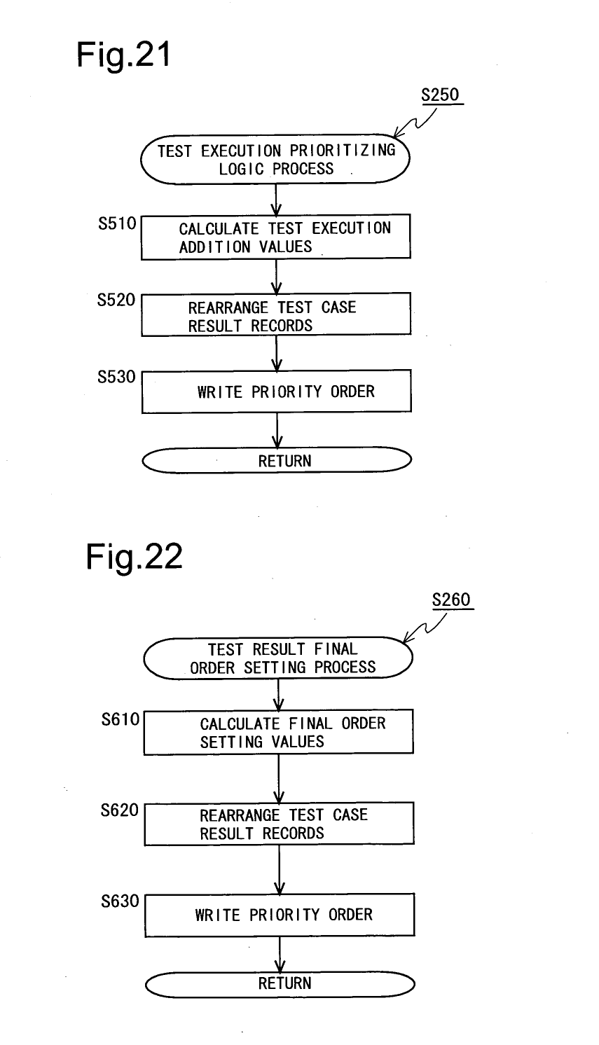

FIG. 21 is a flow chart illustrating a detailed processing procedure for the test execution prioritizing logic process in step S250 of FIG. 9. After the test execution prioritizing logic process is started, the test case extraction apparatus 100 calculates test execution addition values for all test cases of all test specifications included in the test project (step S510). The calculated test execution addition values are written for each test case to the field labeled “TEST EXECUTION ADDITION VALUE” in the priority order setting table 33. Upon completion of step S510, the procedure proceeds to step S520, where test case result records stored in the priority order setting table 33 are rearranged in decreasing order of the test execution addition values. Thereafter, the procedure proceeds to step S530, where a priority order is written for each test case to the field labeled “TEST EXECUTION PRIORITY ORDER” in the priority order setting table 33. Upon completion of step S530, the test execution prioritizing logic process is completed. Note that a program for realizing the test execution prioritizing logic process is stored in the program storage section 20 under the label “TEST EXECUTION PRIORITIZING LOGIC” as shown in FIG. 1.

<3.6 Test Result Final Order Setting Process>

Next, the test result final order setting process is described. As described above, if the test result prioritizing logic process has been carried out, the field labeled “TEST RESULT PRIORITY ORDER” in the priority order setting table 33 contains a priority order based on the test result prioritizing logic process (hereinafter, referred to as the “test result priority order value”). In addition, if the test execution prioritizing logic process has been carried out, the field labeled “TEST EXECUTION PRIORITY ORDER” in the priority order setting table 33 contains a priority level based on the test execution prioritizing logic process (hereinafter, referred to as the “test execution priority order value”). In the present embodiment, the sum of a value obtained by multiplying the test result priority order value by a first coefficient and a value obtained by multiplying the test execution priority order value by a second coefficient (hereinafter, referred to as the “final order setting value”) is calculated for each test case. A test case having a larger final order setting value is assigned a higher priority level.

For example, the first and second coefficients can be set to “1.0” and “0.8”, respectively. In this case, if “CONSIDER TEST RESULTS” and “CONSIDER THINNED-OUT TEST CASES” are selected for PRIORITY LEVEL 1 and PRIORITY LEVEL 2, respectively, as shown in FIG. 8, a final order setting value Z is calculated by the following equation (6).
Z=X×1.0+Y×0.8 (6)
Here, X denotes a test result priority order value, and Y denotes a test execution priority order value.

FIG. 22 is a flow chart illustrating a detailed processing procedure for the test result final order setting process in step S260 of FIG. 9. After the test result final order setting process is started, the test case extraction apparatus 100 calculates final order setting values for all test cases of all test specifications included in the test project (step S610). The calculated final order setting values are written for each test case to the field labeled “FINAL ORDER SETTING VALUE” in the priority order setting table 33. Upon completion of step S610, the procedure proceeds to step S620, where test case result records stored in the priority order setting table 33 are rearranged in decreasing order of the final order setting values. Thereafter, the procedure proceeds to step S630, where a priority level is written for each test case to the field labeled “FINAL ORDER” in the priority order setting table 33. Upon completion of step S630, the test result final order setting process is completed. Note that a program for realizing the test result final order setting process is stored in the program storage section 20 under the label “TEST RESULT FINAL ORDER SETTING” as shown in FIG. 1.

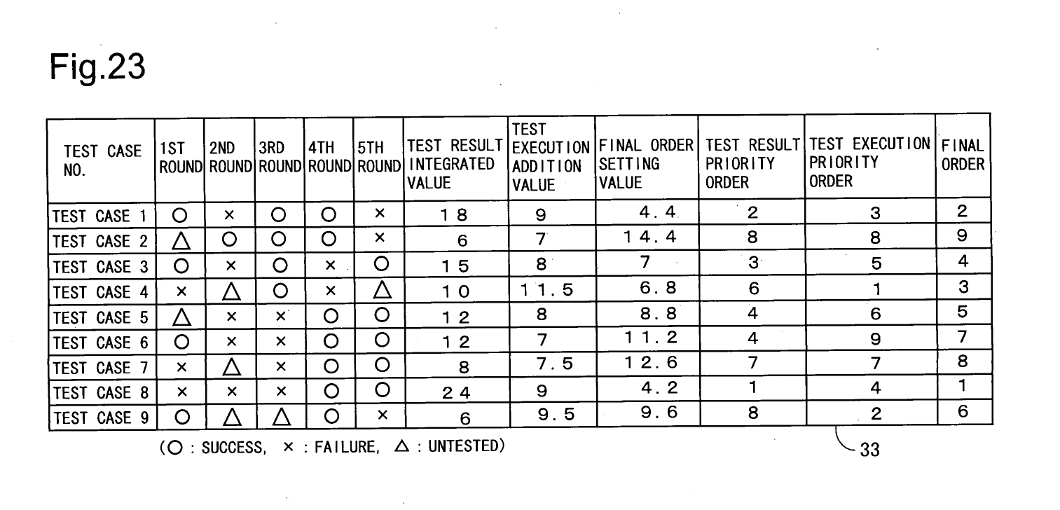

When the test result final order setting process is completed as described above, a priority level for test case extraction is stored for each test case in the field labeled “FINAL ORDER” in the priority order setting table 33 as shown in FIG. 23. In step S270 shown in FIG. 9, test cases that are to be subjected to the current round of testing are extracted based on the above-described priority order and the thinning factors entered in the test specification thinning factor setting text box 407 and the test project thinning factor setting text box 408 shown in FIG. 7.

Note that a test case rearrangement section is realized by step S420 shown in FIG. 16, step S520 shown in FIG. 21 and step S620 shown in FIG. 22.

<4. Advantageous Effects>

As described above, according to the present embodiment, previous test results for each test case are digitized based on each of the test result prioritizing logic and the test execution prioritizing logic. Then, a test result integrated value and a test execution addition value are calculated for each test case. Further, final order setting values for determining the priority order of extracting test cases that are to be subjected to the current round of testing are calculated based on the test result integrated value and the test execution addition value. Therefore, by extracting the test cases in accordance with the final order setting values, suitable test cases that are to be subjected to the current round of testing are extracted from among all test cases with consideration of the previous test results. Thus, it is possible to readily extract test cases with consideration of previous test results, thereby efficiently testing a software system.

Also, the operator can set a priority order among logics applied at the time of test case extraction with the thinning parameter setting dialogue 500. Therefore, it is possible to extract test cases with consideration of previous conditions for test execution, system characteristics and so on. Further, the operator can set test case thinning factors with the test specification thinning factor setting text box 407 and the test project thinning factor setting text box 408 in the test case extraction dialogue 400. Therefore, it is possible to extract test cases that are to be subjected to the current round of testing from among all test cases in accordance with the length of a system development time, the number of man-days allowed for testing, etc. This makes it possible to efficiently extract the test cases, and thoroughly examine malfunctions present in the system with a fewer number of test man-days. As a result, it is made possible to provide a high quality system with a fewer number of man-days.

<5. Variants>

<5.1 First Variant>

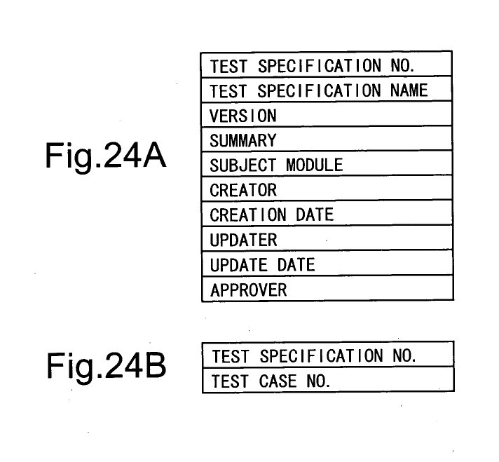

In the above embodiment, “TEST CASE NO.” is repeated by the number of test cases in the test specification table 31 as shown in FIG. 4. The test specification table 31 may be normalized. Specifically, two tables may be used with record formats as shown in FIGS. 24A and 24B.

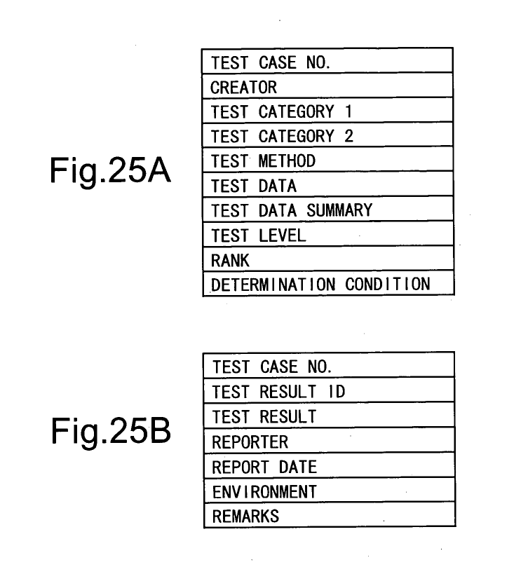

Also, in the above embodiment, “TEST RESULT ID”, “TEST RESULT”, “REPORTER”, “REPORT DATE”, “ENVIRONMENT” and “REMARKS” are repeated by the number of executed tests in the test case table 32 as shown in FIG. 5. The test case table 32 may also be normalized. Specifically, two tables may be used with record formats as shown in FIGS. 25A and 25B.

By normalizing the test specification table 31 and the test case table 32 as described above, the structure of each table is simplified, making it easy to design a program or programming for a test case extraction process. Note that in the present variant, a test case holding section is realized by a table in record format shown in FIG. 25A, and a test result holding section is realized by a table in record format shown in FIG. 25B.

<5.2 Second Variant>

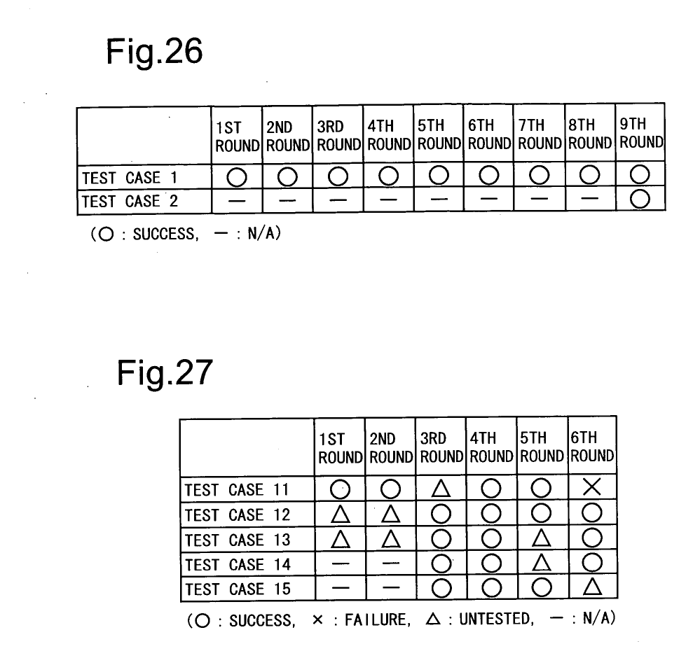

Described next is a notion of the test execution prioritizing logic process, which is different from the notion as described in the above embodiment. First, consider which one of two test cases should be assigned a higher priority level when nine rounds of tests have been previously executed with respect to the two test cases as shown in FIG. 26. Note that “N/A” for a test result is meant to indicate that no test was executed because an associated test case had not yet been generated or the function that was to be tested had not yet been implemented. As for test case 1, the first through ninth round test results are all successes. As for test case 2, on the other hand, the first through eighth round test results are “N/A”, and only the ninth round test result is a success. In this case, it is conceivable that when the next test is executed, the test case 2 having been tested fewer times is more likely to fail than the test case 1. Accordingly, in the case where the test results as shown in FIG. 26 are obtained, the test case 2 is assigned a higher priority level over the test case 1 according to the test execution prioritizing logic of the present variant.

While a simple example has been given above, amore complicated example will be given next. Consider a case of extracting three test cases from five test cases when six rounds of tests have been previously executed with respect to the five test cases as shown in FIG. 27. In this case, it is conceivable that the test cases are extracted, for example, in accordance with the following conditions. A first condition is that “a test case having failed in the last test is prioritized”. A second condition is that “a test case having previously been subjected to a fewer number of tests is prioritized”. In this case, test case 11 is first extracted in accordance with the first condition. Three test cases 13, 14 and 15 are then selected in accordance with the second condition. However, only two out of the three should be extracted, and therefore it is necessary to set another condition or the like.

Accordingly, the test results are digitized as in the above embodiment. In the present variant, each test result is digitized as described below. A successful test result is digitized into “0”. An unsuccessful test result is digitized into, for example, “m+1”, if it is the m-th round test result (where m is an integer). A test result of “untested” is digitized into “(n+1)×0.5”, if it is the n-th round test result (where n is an integer). A test result of “N/A” is digitized into “(p+1)×0.8”, if it is the p-th round test result (where p is an integer). After each test result is digitized as described above, a test execution addition value is calculated for each test case as in the above embodiment. Then, a priority order among the test cases is set based on the test execution addition values.

<5.3 Third Variant>

The above embodiment has been described with respect to the case of executing a test anew after several rounds of tests have been previously executed, e.g., in the case of executing the fifth round test after four rounds of tests have been previously executed as shown in FIG. 13, but the present invention is not limited to this. For example, assume that when the fifth round test is executed, a test case extraction process “extracts three hundred test cases from one thousand test cases”. In some cases, for example, it is desired to, after one hundred test cases have been tested since the start of testing, “narrow down test cases from the remaining two hundred test cases”, because of delay in progress of testing. In such a case also, the present invention is applicable as described below.

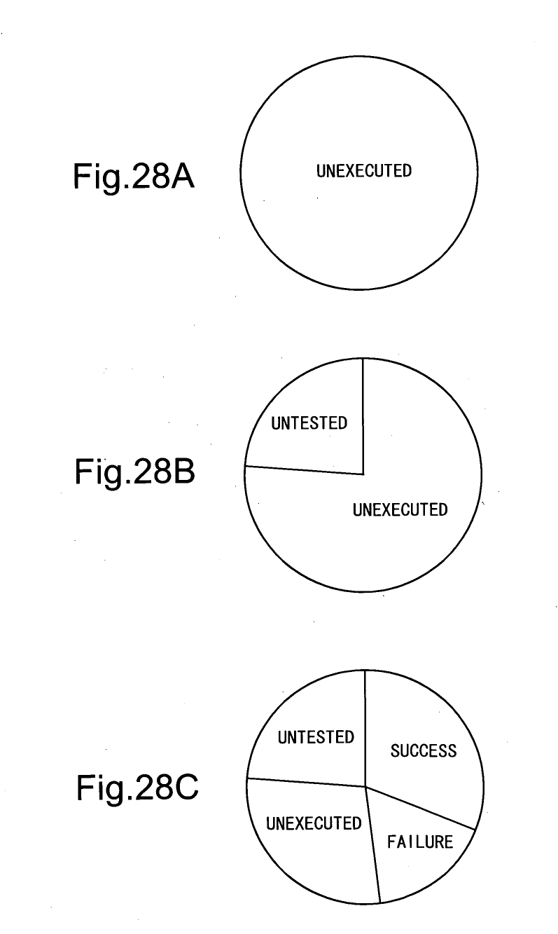

FIGS. 28A, 28B and 28C are charts illustrating changes in proportion of each type of test result among all test results in the course of testing. In the case of executing a new test before performing a test case extraction process, test results for all test cases are “unexecuted” as shown in FIG. 28A. After the test case extraction process is executed, test results for test cases excluded from current test subjects are changed to “untested” as shown in FIG. 28B. Thereafter, upon each execution of a test, the test results of “unexecuted” are changed to “success” or “failure”. As such, the proportion of each test result among all test results is changed during the test phase as shown in FIG. 28C.

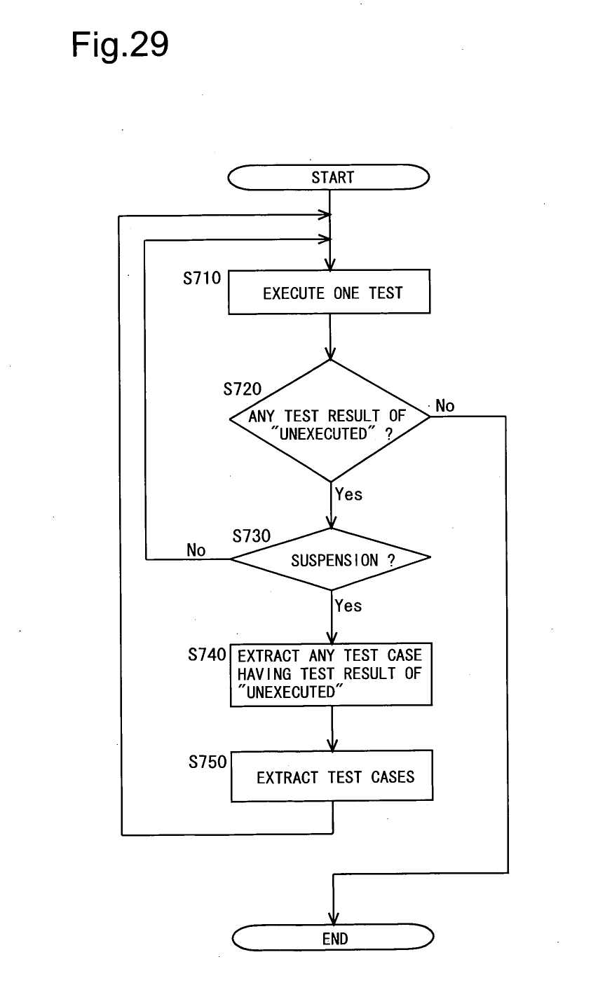

FIG. 29 is a flow chart for explaining a processing flow during a test phase in the present variant. First, when the test phase starts, the operator executes one test (step S710). Test results are written to the field labeled “TEST RESULT” for a corresponding round in the test case table 32. Upon completion of step S710, the procedure proceeds to step S720, where it is determined whether there is any test case having a test result of “unexecuted”. When it is determined that test cases having a test result of “unexecuted” are present, the procedure proceeds to step S730. On the other hand, when it is determined that there is no test case having a test result of “unexecuted”, the procedure is completed. In step S730, it is determined whether or not to suspend the testing. When it is determined to suspend the testing, the procedure proceeds to step S740. On the other hand, when it is not determined to suspend the testing, the procedure returns to step S710 to continue the testing. In step S740, the test cases having a test result of “unexecuted” in the current round of testing are extracted from the test case table 32. Thereafter, the procedure proceeds to step S750, where the test cases extracted in step S740 are further narrowed down, i.e., further extraction is performed. As a result, test results for test cases excluded from current test subjects are changed from “unexecuted” to “untested”. Upon completion of step S750, the procedure returns to step S710 to continue the testing.

With the above configuration, it is possible to, for example, when there is delay in progress of testing, narrow down test cases, thereby efficiently reducing test cases that are to be subjected to the current round of testing. Note that an unexecuted test case extraction section is realized by step S740.

In addition, the test cases having a test result of “unexecuted” are extracted in step S740, but instead of this, test cases having a test result of “unexecuted” and test cases having a test result of “untested” may be extracted. As a result, the unexecuted test case extraction section and a currently excluded test case extraction section are realized by step S740. With this configuration, as opposed to the foregoing, it is possible to increase the test cases that are to be subjected to the current round of testing. As a result, it is possible to increase the number of test cases that are to be subjected to the current round of testing, thereby improving system quality.

<5.4 Fourth Variant>

In the above embodiment, test cases are extracted based only on previous test results, but the present invention is not limited to this. For example, it may be so configured that test cases are extracted with consideration of their importance levels as well as previous test results. This makes it possible to extract important test cases as current test subjects even if their previous test results are all “successes”. As a result, it is possible to extract test cases with consideration of previous test results and without leaving out any important test case.

<6. Others>

The above-described test case extraction apparatus 100 is realized based on programs 21 through 24 such as table creation executed by the CPU 10 on the premise that hardware such as the memory 60 and the auxiliary storage 70 is present. Part or all of the programs 21 through 24 is provided by, for example, a computer readable storage medium, such as a CD-ROM, which has the programs 21 through 24 stored therein. The user can purchase a CD-ROM as a storage medium of the programs 21 through 24, and load it into a CD-ROM drive unit, so that the programs 21 through 24 are read therefrom and installed to the auxiliary storage 70 of the test case extraction apparatus 100. As such, it is possible to provide each step as shown in FIG. 6 and so on in the form of a computer executable program.

While the invention has been described in detail, the foregoing description is in all aspects illustrative and not restrictive. It is understood that numerous other modifications and variations can be devised without departing from the scope of the invention.

Note that the present application claims priority to Japanese Patent Application No. 2005-291366, titled “TEST CASE EXTRACTION APPARATUS, PROGRAM AND METHOD FOR SOFTWARE SYSTEM”, filed on Oct. 4, 2005, and hereby incorporated by reference in its entirety.

What is claimed is:

1. A test case extraction apparatus for extracting an execution subject test case group from a created test case group, the execution subject test case group consisting of a plurality of test cases that are to be subjected to a current round of testing, the created test case group consisting of a plurality of previously created test cases that are repeatedly tested, the apparatus comprising:
a test case holding section for holding the created test case group;
a test result holding section for holding round-by-round test results associated with each test case in the created test case group;
a test result reading section for reading the round-by-round test results held in the test result holding section; and
a test case extraction section for extracting the execution subject test case group from the created test case group based on the round-by-round test results read by the test result reading section.

2. The test case extraction apparatus according to claim 1,
wherein the test case extraction section includes a priority order setting section for setting a priority order among the test cases in the created test case group based on the round-by-round test results read by the test result reading section, in order to determine test cases that are to be extracted as the execution subject test case group, and
wherein the execution subject test case group is extracted from the created test case group based on the priority order.

3. The test case extraction apparatus according to claim 2, wherein the priority order setting section includes a test case rearrangement section for rearranging the created test case group based on the round-by-round test results read by the test result reading section.

4. The test case extraction apparatus according to claim 1, further comprising an extraction factor setting section for setting a percentage of test cases that are extracted as the execution subject test case group from the created test case group or a percentage of test cases that are unextracted as the execution subject test case group from the created test case group,
wherein the test case extraction section extracts the execution subject test case group from the created test case group based on the percentage set by the extraction factor setting section.

5. The test case extraction apparatus according to claim 1, further comprising an extraction logic setting section for setting a priority order among a plurality of logics for extracting the execution subject test case group from the created test case group,
wherein when extracting the execution subject test case group from the created test case group, the test case extraction section applies the plurality of logics in accordance with the priority order set by the extraction logic setting section.

6. The test case extraction apparatus according to claim 1, further comprising an unexecuted test case extraction section for extracting test cases that are not subjected to the current round of testing from the execution subject test case group,
wherein test cases that are to be subjected to the current round of testing are extracted from the test cases extracted by the unexecuted test case extraction section.

7. The test case extraction apparatus according to claim 1, further comprising a currently excluded test case extraction section for extracting test cases that are excluded from current test subjects from among the created test case group,
wherein the test cases that are to be subjected to the current round of testing are extracted from the test cases extracted by the currently excluded test case extraction section.

8. The test case extraction apparatus according to claim 1,
wherein the test result holding section holds pass/fail distinction information as the round-by-round test results for each test case in the created test case group, the pass/fail distinction information allowing distinction as to whether testing is successful or not, and
wherein the test case extraction section extracts the execution subject test case group from the created test case group based on the pass/fail distinction information.

9. The test case extraction apparatus according to claim 8,
wherein the test result holding section holds no-execution information as a test result for a test case in a round of testing, the no-execution information indicating that no test has been executed, and
wherein the test case extraction section extracts the execution subject test case group from the created test case group with consideration of the no-execution information.

10. The test case extraction apparatus according to claim 8, wherein when a test result for a test case in a round of testing is not included in the round-by-round test results for each test case in the created test case group because of absence of the test case or a predetermined function associated with the test case, the test case extraction section extracts the execution subject test case group from the created test case group with consideration of the round of testing in which no test result is available for the test case.

11. A test case extraction program for extracting an execution subject test case group from a created test case group, the execution subject test case group consisting of a plurality of test cases that are to be subjected to a current round of testing, the created test case group consisting of a plurality of previously created test cases that are repeatedly tested, the program causing a computer to execute:
a test result reading step for reading round-by-round test results associated with each test case in the created test case group held in a predetermined test case holding section from a predetermined test result holding section holding test results for the plurality of test cases; and
a test case extraction step for extracting the execution subject test case group from the created test case group based on the round-by-round test results read by the test result reading step.

12. The test case extraction program according to claim 11,
wherein the test case extraction step includes a priority order setting step for setting a priority order among the test cases in the created test case group based on the round-by-round test results read by the test result reading step, in order to determine test cases that are to be extracted as the execution subject test case group, and
wherein the execution subject test case group is extracted from the created test case group based on the priority order.

13. The test case extraction program according to claim 12, wherein the priority order setting step includes a test case rearrangement step for rearranging the created test case group based on the round-by-round test results read by the test result reading step.

14. The test case extraction program according to claim 11, further comprising an extraction factor setting step for setting a percentage of test cases that are extracted as the execution subject test case group from the created test case group or a percentage of test cases that are unextracted as the execution subject test case group from the created test case group,
wherein, in the test case extraction step, the execution subject test case group is extracted from the created test case group based on the percentage set by the extraction factor setting step.

15. The test case extraction program according to claim 11, further comprising an extraction logic setting step for setting a priority order among a plurality of logics for extracting the execution subject test case group from the created test case group,
wherein, in the test case extraction step, when extracting the execution subject test case group from the created test case group, the plurality of logics are applied in accordance with the priority order set by the extraction logic setting step.

16. The test case extraction program according to claim 11, further comprising an unexecuted test case extraction step for extracting test cases that are not subjected to the current round of testing from the execution subject test case group,
wherein test cases that are to be subjected to the current round of testing are extracted from the test cases extracted by the unexecuted test case extraction step.

17. The test case extraction program according to claim 11, further comprising a currently excluded test case extraction step for extracting test cases that are excluded from current test subjects from among the created test case group,
wherein the test cases that are to be subjected to the current round of testing are extracted from the test cases extracted by the currently excluded test case extraction step.

18. The test case extraction program according to claim 11,
wherein, in the test case extraction step, the execution subject test case group is extracted from the created test case group based on pass/fail distinction information held in the test result holding section as the round-by-round test results for each test case in the created test case group, the pass/fail distinction information allowing distinction as to whether testing is successful or not.

19. The test case extraction program according to claim 18,
wherein, in the test case extraction step, the execution subject test case group is extracted from the created test case group with consideration of no-execution information held in the test result holding section as a test result for a test case in a round of testing, the no-execution information indicating that no test has been executed.

20. The test case extraction program according to claim 18, wherein, in the test case extraction step, when a test result for a test case in a round of testing is not included in the round-by-round test results for each test case in the created test case group because of absence of the test case or a predetermined function associated with the test case, the execution subject test case group is extracted from the created test case group with consideration of the round of testing in which no test result is available for the test case.

21. A test case extraction method for extracting an execution subject test case group from a created test case group, the execution subject test case group consisting of a plurality of test cases that are to be subjected to a current round of testing, the created test case group consisting of a plurality of previously created test cases that are repeatedly tested, the method comprising:
a test result reading step for reading round-by-round test results associated with each test case in the created test case group held in a predetermined test case holding section from a predetermined test result holding section holding test results for the plurality of test cases; and
a test case extraction step for extracting the execution subject test case group from the created test case group based on the round-by-round test results read by the test result reading step.

22. The test case extraction method according to claim 21,
wherein the test case extraction step includes a priority order setting step for setting a priority order among the test cases in the created test case group based on the round-by-round test results read by the test result reading step, in order to determine test cases that are to be extracted as the execution subject test case group, and
wherein the execution subject test case group is extracted from the created test case group based on the priority order.

23. The test case extraction method according to claim 22, wherein the priority order setting step includes a test case rearrangement step for rearranging the created test case group based on the round-by-round test results read by the test result reading step.

24. The test case extraction method according to claim 21, further comprising an extraction factor setting step for setting a percentage of test cases that are extracted as the execution subject test case group from the created test case group or a percentage of test cases that are unextracted as the execution subject test case group from the created test case group,
wherein, in the test case extraction step, the execution subject test case group is extracted from the created test case group based on the percentage set by the extraction factor setting step.

25. The test case extraction method according to claim 21, further comprising an extraction logic setting step for setting a priority order among a plurality of logics for extracting the execution subject test case group from the created test case group,
wherein, in the test case extraction step, when extracting the execution subject test case group from the created test case group, the plurality of logics are applied in accordance with the priority order set by the extraction logic setting step.

26. The test case extraction method according to claim 21, further comprising an unexecuted test case extraction step for extracting test cases that are not subjected to the current round of testing from the execution subject test case group,
wherein test cases that are to be subjected to the current round of testing are extracted from the test cases extracted by the unexecuted test case extraction step.

27. The test case extraction method according to claim 21, further comprising a currently excluded test case extraction step for extracting test cases that are excluded from current test subjects from among the created test case group,
wherein the test cases that are to be subjected to the current round of testing are extracted from the test cases extracted by the currently excluded test case extraction step.

28. The test case extraction method according to claim 21,
wherein, in the test case extraction step, the execution subject test case group is extracted from the created test case group based on pass/fail distinction information held in the test result holding section as the round-by-round test results for each test case in the created test case group, the pass/fail distinction information allowing distinction as to whether testing is successful or not.

29. The test case extraction method according to claim 28,
wherein, in the test case extraction step, the execution subject test case group is extracted from the created test case group with consideration of no-execution information held in the test result holding section as a test result for a test case in a round of testing, the no-execution information indicating that no test has been executed.

30. The test case extraction method according to claim 28, wherein, in the test case extraction step, when a test result for a test case in a round of testing is not included in the round-by-round test results for each test case in the created test case group because of absence of the test case or a predetermined function associated with the test case, the execution subject test case group is extracted from the created test case group with consideration of the round of testing in which no test result is available for the test case.
